(19) United States
(12) Patent Application Publication
(10) Pub. No.: US 2003/0233457 A1
(43) Pub. Date: Dec. 18, 2003

(54) Signaling framework for wireless networks

(76) Inventors: Henrik Basilier, San Diego, CA (US); Anders Lundstrom, La Jolla, CA (US)

Correspondence Address: COATS & BENNETT, PLLC, P O BOX 5, RALEIGH, NC, 27602, US

(21) Appl. No.: 10/171,525

(22) Filed: Jun. 12, 2002

(51) Int. Cl. G06F 15/16

(52) U.S. Cl. 709/227

(57) ABSTRACT

A signaling framework for wireless communications over an air interface of a wireless network comprises an application layer containing an application for communicating with a remote device and for generating adaptation control directives associated with signaling messages, a wireless adaptation layer to control wireless communication resources of the wireless network used to transmit said signaling messages over said air interface responsive to said wireless adaptation control directives, and a session control protocol layer between said application layer and said wireless adaptation layer to establish and maintain a communication session between the application and the remote device.

### BACKGROUND OF THE INVENTION

The present invention relates to signaling frameworks for wireless communications and more particularly to a signaling framework that allows applications to control the manner in which designated signaling messages are transmitted by a wireless network.

Mobile communications have existed for decades and reached mass markets in the 1990s. While wireless networks were originally developed to provide voice services, there is a growing demand for wireless data services. Significant effort is being expended by various standardization bodies to define frameworks and protocols for IP-based services. These new protocols will enable consumers to access voice and data services typically found in only wire-line networks, such as the Internet. These evolving protocols, such as the Session Initiation Protocol (SIP), rely on the Internet protocol (IP) for transport and use IP-based protocols. These IP-based protocols allow rapid, cost effective development and deployment of innovative voice and multi-media services without concern for the underlying transport network, and enable interoperability between disparate devices ranging from cellular telephones to laptop computers.

Adapting IP-based protocols developed for wire-line networks for mobile computing environments presents many challenges. Many of the IP-based protocols, such as SIP, are text based. The signaling messages used in these protocols tend to be large. Because radio resources in a wireless network are scarce, the transmission of numerous large signaling messages could consume significant bandwidth that could be used for voice and data services. Further, larger message size typically implies longer transmission time. Many applications are sensitive to delays; thus long packet latencies are undesirable. Packet loss is another concern in wireless networks. Many applications are sensitive to data loss, i.e., dropped packets, so a means for reliable transmission is needed. Another concern is efficient use of communication resources in the wireless network. There may be circumstances when it is more efficient to send packets associated with signaling messages over a particular channel to conserve communication resources.

The signaling protocols being developed for wireless data services are IP-based networks and are designed to be access independent. While much effort is being expended to make such signaling protocols as efficient and reliable as possible, messages delivered over wireless networks may require special treatment to optimize use of radio resources or to make communications more reliable.

### SUMMARY OF THE INVENTION

The present invention provides a signaling framework for wireless communications that allows applications to control the way in which signaling messages are transmitted over a wireless network so as to optimize use of radio resources or to guarantee a certain level of reliability. The present invention may be used, for example, to control the manner in which signaling messages are transmitted between a base station and a mobile terminal.

The signaling framework includes an application layer, a session control protocol layer, and a wireless adaptation layer (WAL). The application layer contains an application for communicating with remote devices. The session control protocol layer resides below said application layer and maintains a communication session between two devices. The wireless adaptation layer resides below said session control protocol layer and controls the manner in which signaling messages are transmitted over an air interface.

The application generates signaling messages and associated wireless adaptation control directives, both of which get sent to the wireless adaptation layer through the session control protocol layer. Alternatively, the application may generate signaling messages having wireless control directives embedded therein. The wireless adaptation layer is responsive to the wireless adaptation control directives to control how signaling messages should be transmitted. For example, the wireless adaptation layer may use a different signaling compression algorithm for designated signaling messages, or may request that special signaling bearers or other resources be used to transmit the signaling messages over a wireless network. For example, the wireless application layer may elect to use a common channel rather than a dedicated channel to transmit certain messages to minimize transmission delays. In a preferred embodiment, the wireless adaptation control directives pass transparently through the session control protocol layer from the application to the wireless adaptation layer.

The application may associate each wireless adaptation control directive with a specific signaling message to allow the wireless adaptation layer to determine on a message by message basis how to transmit signaling messages over the air interface. For example, the application could associate a wireless adaptation control directive with messages requiring special treatment. Signaling messages not associated with a wireless adaptation control directive would be subjected to default handling.

The application may use explicit signaling or implicit signaling to pass wireless adaptation control directives through the session control protocol layer to the wireless adaptation layer. Explicit signaling may comprise inserting information into the signaling message, e.g., in a header field for example, that is ignored by the session control protocol layer. As an example of implicit signaling, the application may use different port numbers for different signaling messages. That is, the application may use a specific port, e.g., user datagram protocol (UDP) port or transmission control protocol (TCP) port, for signaling messages requiring special treatment. The session control protocol layer passes port information transparently through to the wireless adaptation layer but otherwise ignores port numbers. The WAL processes the signaling messages differently based on the port over which the message is received.

### BRIEF DESCRIPTION OF THE DRAWINGS

FIG. 1 is a functional block diagram of a wireless network using the signaling framework of the present invention.

FIG. 2 is a functional block diagram illustrating the IP multimedia subsystem and its relationship to the core network in the wireless network of FIG. 1.

FIG. 3 is a diagram illustrating data and signaling flow paths between wireless networks.

FIG. 4 is a diagram of a signaling framework for IP-based communications according to the prior art.

FIG. 5 is a diagram of a signaling framework for IP-based communications according to the present invention.

FIG. 6 is a diagram illustrating end to end signaling between mobile terminals according to the present invention.

FIG. 7 is a diagram illustrating signaling between a mobile terminal and a home network according to the present invention.

### DETAILED DESCRIPTION OF THE INVENTION

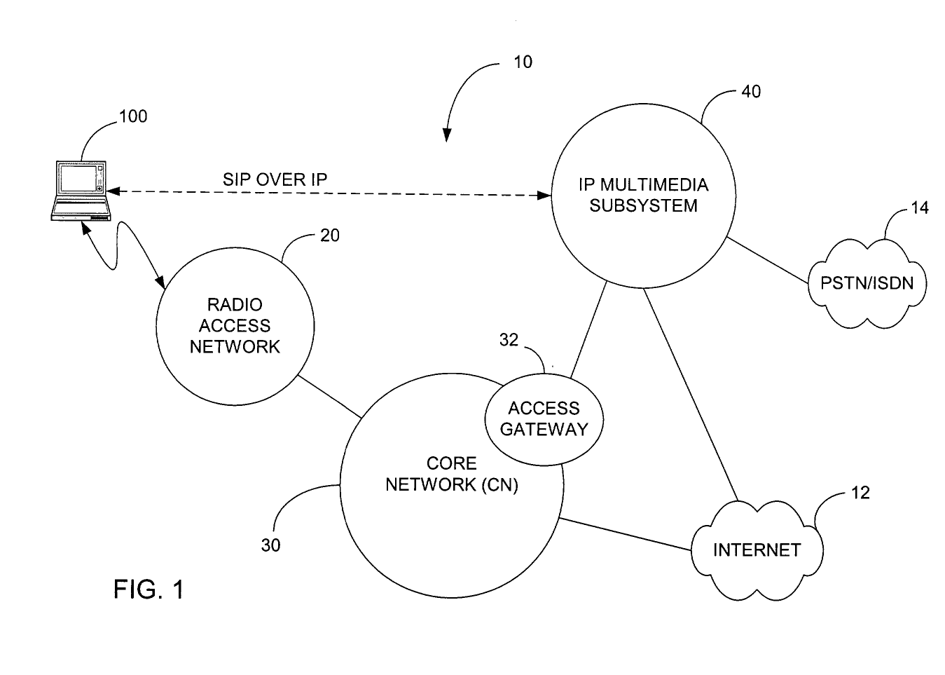

FIG. 1 illustrates the main functional elements of a wireless network 10 that employs the signaling framework of the present invention. The wireless network comprises a radio access network (RAN) 20, a core network (CN) 30, and an IP Multimedia Subsystem (IMS) 40. The RAN 20 supports radio communications with mobile terminals 100 over an air interface, such as cdma2000 or wideband CDMA (W-CDMA). The wireless network 10 typically includes more than one RAN 20 though only one is shown in FIG. 1. The CN 30 provides a connection to the Internet 12 or other packet data network (PDN) for packet switched services such as Internet access, and may provide a connection to the Public Switched Telephone Network (PSTN) 14 and/or the Integrated Digital Services Network (ISDN) 16 for circuit-switched services, such as voice and fax services. The CN 30 may, for example, comprise a General Packet Radio Services (GPRS) network or a cdma2000 network. Other types of network could also be used. The CN 30 includes an access gateway 32 for interconnecting with the IMS 40. The access gateway 32 may comprise a GPRS Gateway Serving Node (GGSN) for GPRS networks or a Packet Data Serving Node (PDSN) for cdma2000 networks. The IMS 40 provides access independent, IP-based multi-media services to mobile subscribers and supports voice over IP (VoIP). While the present invention is described in the context of communications between a mobile terminal 100 and an IMS 40, it is useful in other contexts where signaling messages need to be transmitted over a wireless network 10. Therefore, the description of the invention in this context should not be construed as limiting the invention.

The IMS 40 uses open interfaces and an access independent session control protocol (SCP), such as the Session Initiation Protocol (SIP), to support multi-media applications. The SIP is an application layer control protocol for establishing, modifying and terminating communication sessions between one or more participants. These sessions may include, for example, Internet multimedia conferences, Internet telephony calls, and multimedia distributions. The SIP is described in the IETF document RFC 2543. While a preferred embodiment of the invention as described herein uses the SIP, those skilled in the art will appreciate that the present invention may use other SCPs as well. Another well-known protocol comparable to the SIP is H. 323. The details of the SIP are not material to the present invention, but a brief overview of the SIP is given below to better place the invention in context.

SIP is a signaling protocol that uses ASCII-based signaling messages to establish a conference or call between two or more participants. Users are identified by a unique address referred to herein as the SIP address. Users register with a registrar server using their assigned SIP addresses. The registrar server provides this address to a location server upon request.

When a user initiates a call, a SIP request is sent to a SIP server (either a proxy server or a redirect server). The request includes the calling party address and called party address in a message header. If a proxy server receives the SIP request, it forwards the SIP request to the called party. The called party may be another user or may be an application server in the user's home network. The called party responds to the proxy server, which in turn, forwards the response to the calling party. The calling party acknowledges the response and a session is then established between the calling party and the called party. Real-time Transfer Protocol (RTP) is used for the communication between the calling party and the called party.

If a redirect server receives the SIP request, the redirect server contacts the location server to determine the path to the called party, and then sends that information to the calling party. The calling party acknowledges receipt of the information and then resends the SIP request to the server identified in the redirection information (which could be the called party of a proxy server). When the SIP request reaches the called party, the called party responds and the calling party acknowledges the response. communications then begin using RTP. SIP is used only to process signaling messages related to call control and session management.

As described above, SIP enables applications within the wireless network 10 to establish a communications session. The applications may reside in a mobile terminal 100 or in an application server in the IMS 40. Additionally, the applications may reside in different networks 10.

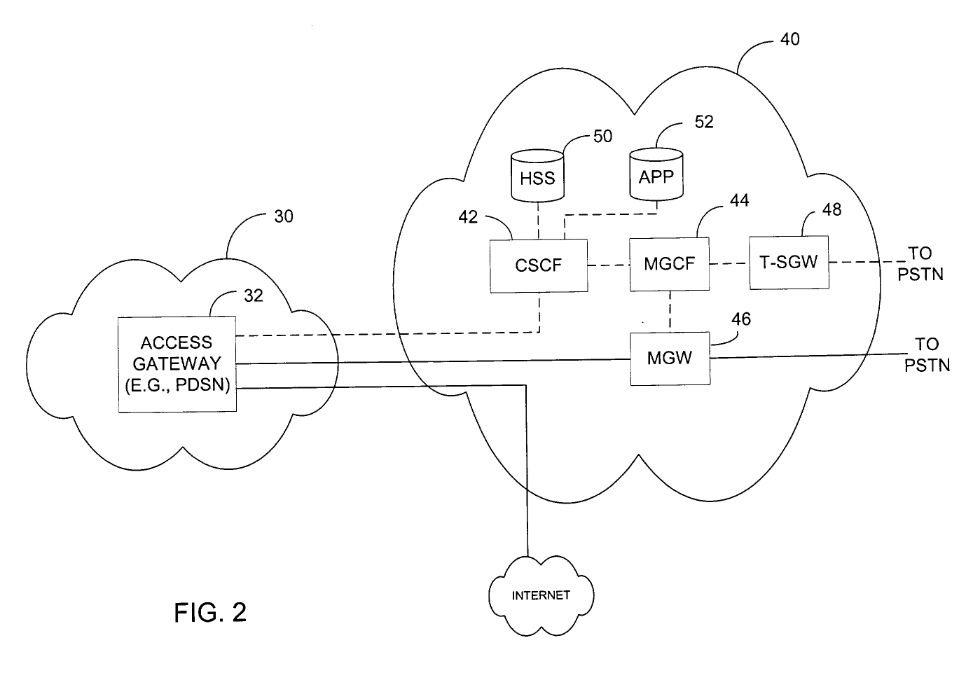

FIG. 2 illustrates the basic elements of the IMS 40 and its relationship to the CN 30. The IMS 40 includes one or more Call State Control Functions (CSCFs) 42, a Media Gateway Control Function (MGCF) 44, a Media Gateway (MGW) 46, a Transport Signaling Gateway (T-SGW) 48, and a Home Subscriber Server (HSS) 50, which are interconnected by an IP network. The IMS 40 may further include an application server 52 providing multimedia services to mobile terminals 100. The CSCFs 42 function as SIP servers to process session control signaling used to establish, maintain and terminate a communication session. The protocol used for a majority of the signaling in the IMS 40 is the SIP. Functions performed by the CSCFs 42 include call control, address translation, authentication, capability negotiation, and subscriber profile management. The IMS 40 may include additional elements, such as MRFP and MRFC.

The HSS 50 interfaces with the CSCFs 42 to provide information about the subscriber's current location and subscription information. The application server provides multimedia services or other services to mobile subscribers.

The MGCF 44, MGW 46 and T-SGW 48 support interworking with external networks, such as the PSTN or ISDN. The MGCF 44 controls one or more MGWs 46 that manage the connections between the external network and the IMS 40. The MGCF 44 configures the MGW 46 and converts SIP messages into a different format, such as ISDN User Part (ISUP) messages. The MGCF 44 forwards the converted messages to the T-SGW 48, which interfaces the IMS 40 to external signaling network, such as the SS7 network. The T-SGW 48 includes a protocol converter to convert IP messages to SS7 and vice versa.

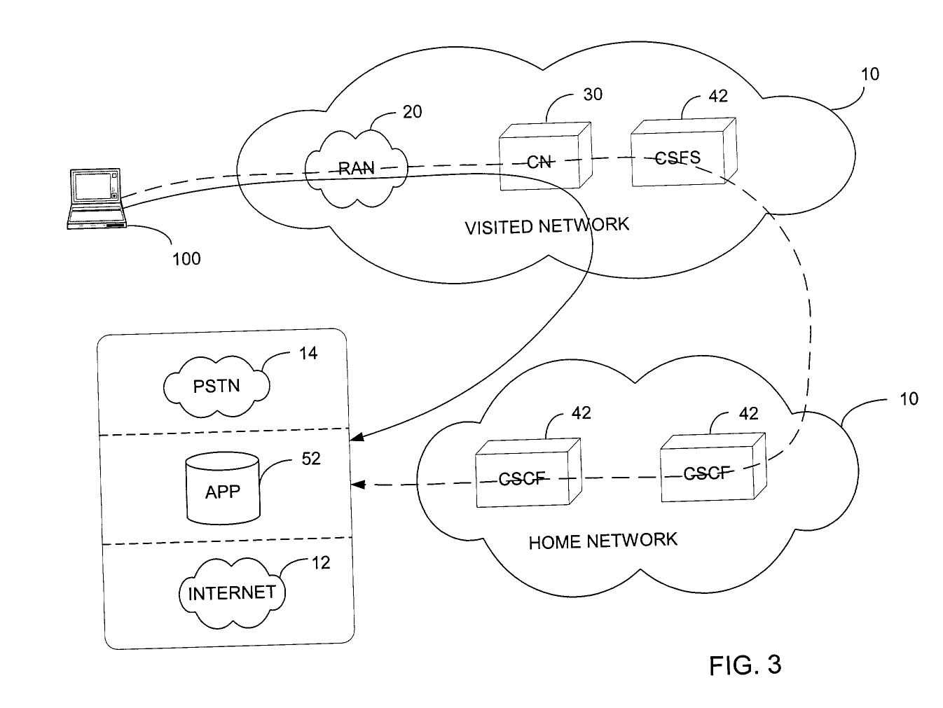

FIG. 3 illustrates an exemplary flow of signaling messages and user data in a typical communication session initiated by a mobile terminal 100. To send and receive SIP messages over the wireless network 10, the mobile terminal 100 establishes a bi-directional packet data session with the IMS 40, which is illustrated in FIG. 1 by a dotted line to establish a signaling path. The signaling path must be established before any SIP messages can be sent.

Signaling messages originating with the mobile terminal 100 follows the path illustrated by a dotted line in FIG. 3. Signaling messages pass through the RAN 20, and CN 30, to a CSCF 42 in a visited mobile network 10 functioning as a proxy server. The CSCF 42 in the visited network forwards the signaling messages to the home network 10. A CSCF 42 in the IMS 40 of the home network forwards the SIP message to the appropriate destination, which may be a mobile terminal 100, an application server 52 within the home network 10, a third party application server in a different network 10, or to PSTN or ISDN. A CSCF 42, referred to as the serving CSCF 42, in the home network provides call control session management for the session.

User data follows a different path (shown by a solid line) than signaling messages. User data passes through the RAN 20 and CN 30 in the visited network. The user data, however, bypasses the CSCFs 42 and passes directly to the Internet or to the MGW 46. A similar signaling and data flow exists for signaling messages and data traveling from an application server 52 in the wireless network 10 to the mobile terminal 100.

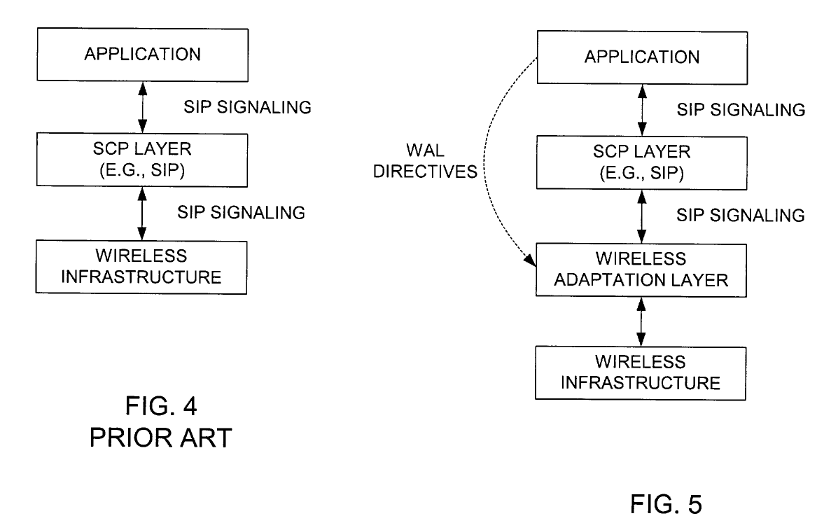

FIG. 4 shows the relationship between the SCP and other protocols in a conventional signaling framework. For simplicity, protocol layers not pertinent to the invention are omitted. The SCP layer is between the application layer and the wireless infrastructure. The SCP layer performs functions needed to establish, maintain, modify, and terminate calls between two or more parties. The most common SCP is SIP. These messages may, for example, use IP for transport over the air interface. The SCP layer in the network 10 provides supporting functions such as message routing, authentication, authorization, accounting, location management, capability negotiation, and security. Signal compression may be implemented in the SCP layer to allow messages to be sent more efficiently over the wireless infrastructure/air interface. Also, SIP messages may be subjected to special treatment by the access gateway 32.

SIP, or some other session control protocol, enables applications to communicate with one another regardless of the underlying transport network. However, the generic call processing and session management functions implemented by SIP are not always well suited for communications over a wireless network 10. Because SIP is a text based protocol, some messages are long and may require additional compression beyond that provided by SIP. Also, some messages may require special treatment for transmission over the wireless network 10 to guarantee response times or optimize use of radio resources.

The ability of the access gateway 32 to apply special treatment to all SIP messages does not provide the flexibility needed for communications over the wireless network 10. Not all SIP messages will require special treatment for transmission of the wireless network 10. Applying special treatment to all SIP messages, therefore, may lead to insufficient use of resources. Currently, there is no way to identify those particular SIP messages requiring special treatment for transmission over the wireless network 10.

As one example, SIP may be used to establish a communication session for a push-to-talk telephony application in a mobile terminal 100. When the user presses to talk, the SIP client in the mobile terminal 100 sends an INVITE message to the called party. It is desirable for this application that the INVITE message be delivered as quickly as possible, otherwise a session may not be established by the time that the user begins speaking and speech data may be lost. The SCP layer is not context sensitive and has no way of knowing that the INVITE message requires special treatment for this particular application. Therefore, it would be beneficial if the INVITE message could be flagged by the push-to-talk application in the mobile terminal 100 for special treatment.

The present invention provides a new signaling framework that enables applications to identify particular signaling messages that require special treatment. According to the present invention, a wireless adaptation layer (WAL) is inserted in the protocol stack between the SCP layer and transport medium as shown in FIG. 5. The WAL is a new protocol layer that performs tasks related to optimizations for communications over a wireless communication link. The functional entities within the WAL may reside in various network components, such as a CSCF 42 in the IMS 40 or in a base station controller in the RAN 20. That is, the functions of the wireless application layer may be distributed among network components as needed depending on the optimizations to be performed. The WAL determines on a per message basis whether to subject signaling messages to special treatment or to a default treatment. Special treatment may, for example, comprise transmitting the signaling message over a specific radio channel, using a specific bearer service, or using signaling compression or other techniques to minimize use of radio resources. Applications communicate with the WAL by generating wireless adaptation control directives that are associated with signaling messages that require special treatment. These directives are ignored by the SCP layer and are processed in the WAL. This transparent signaling between the application layer and the WAL across the SCP layer is illustrated in FIG. 5. Thus, an application in a mobile terminal 100 or an application server 52 can request special treatment of particular SIP messages without modifying the SCP layer.

In the push-to-talk example given above, the application can send a wireless adaptation directive to the WAL to request special treatment of the INVITE message. The WAL may decide to use a common channel rather than a dedicated channel to transmit the INVITE message to the network to reduce transmission delays. If a dedicated channel is already established and available, the WAL may use the dedicated channel. The WAL may also compress the INVITE message to reduce transmission time over the air interface to the network. Compression also reduces waste of common resources if a common channel is used.

The method of giving wireless adaptation control directives to the WAL may vary, depending upon the session control protocol being used. Both explicit and implicit signaling methods may be used. As an example of explicit signaling, the application may insert information into a signaling message, e.g. SIP message, that passes transparently through the SCP layer and is processed in the WAL. This method allows new functions to be added to the applications and the WAL without making changes in the SCP layer. As an example of implicit signaling, the application may use different port numbers for different message types. That is, the application may use a specific port, e.g., UDP or TCP port, for signaling messages requiring special treatment. The SCP layer could be designed to pass port information transparently but to otherwise ignore port numbers. The WAL would process messages differently based on the port over which the message is received. For example, the access gateway 32 or base station controller in the RAN 20 may identify SIP messages needing special treatment by matching packets corresponding to SIP messages to a specific port, e.g., UDP or TCP port and apply special treatment to packets matching the designated port. The special treatment might comprise, for example, sending the packet over a specific channel, or configuring a communication channel in a specific way to provide greater reliability or reduce delays.

Using a WAL, optimization of the communication resources used to transmit the signaling message may be performed locally between the mobile terminal 100 and the network 10. The optimizations can be negotiated between the mobile terminal 100 and a visited network at the time the mobile terminal 100 registers with the network 10. SIP, for example, contains support for capability negotiation. This negotiation could involve the SCP layer, but could also take place entirely within the WAL, making the optimizations totally transparent to the layers above.

Since optimizations are performed locally, there is no requirement that all entities involved in a call implement the WAL. For example, as shown in FIG. 5, a mobile terminal 100 supporting WAL extensions can communicate with another mobile terminal 100 that does not support the WAL extensions. Such communication is possible because the protocols in the SCP layer perform call control and session management independently of the mechanism used for transport. The WAL directives will simply be ignored by any entities that do not recognize those directives.

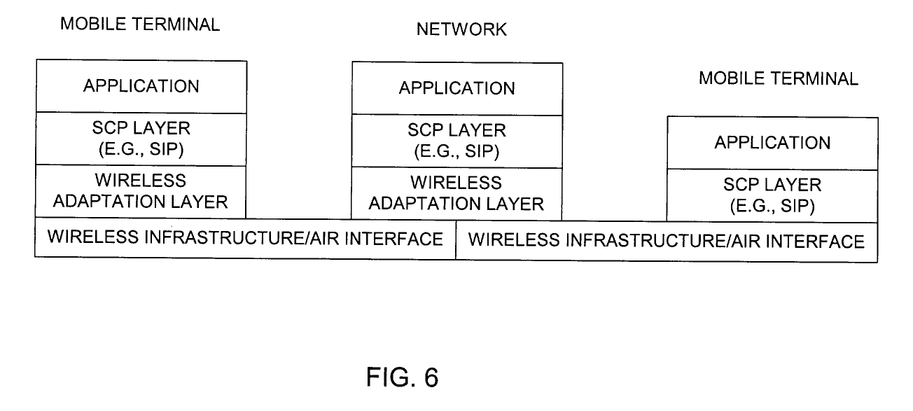

The WAL directives can also be used in true end-to-end fashion as shown in FIG. 6. They can be added by any of the applications shown in FIG. 6, including applications within the network 10. An application residing in a mobile terminal 100 that does not support the WAL functionality can, itself, associate directives with a SIP message to control a function in the WAL in the network 10 or at a receiving mobile terminal 100.

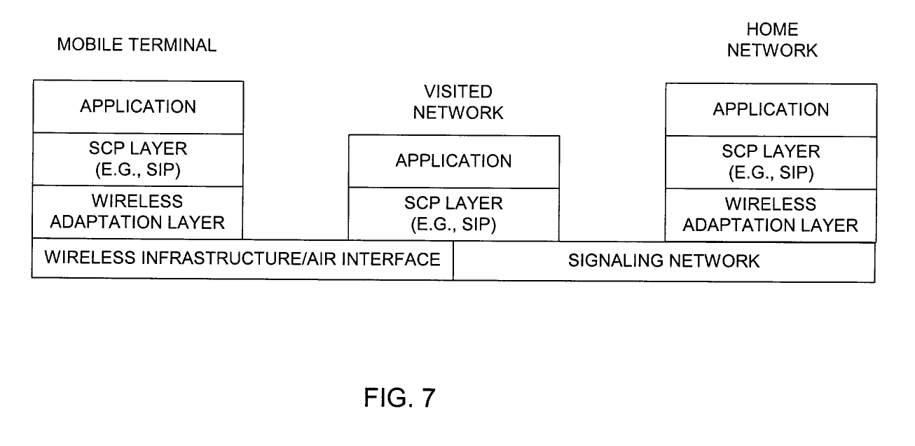

FIG. 7 illustrates signaling between a mobile terminal 100 in a visited network and the home network. As shown in FIG. 7, there is no requirement that the visited network implement the WAL protocols. The wireless adaptation directives will simply pass transparently through the visited network to the home network 10. Entities that do not recognize the directive will still be able to receive and process the signaling messages conventionally. The only consequence is that the optimizations may not be performed.

The special handling required for a particular message may be implemented in the WAL itself. For example, where a particular signal compression method is required, such compression can be implemented in the WAL. In other cases, special handling will necessarily involve the access network and/or air interface. For mobile terminals, this type of special handling is not a problem. The special handling may be negotiated between the mobile terminal 100 and wireless network 10 by the WAL. Setting up special handling for messages transmitted to the mobile terminal 100 may require a different treatment. In this case, the application associates a directive with the message to be transmitted to the mobile terminal 100. The WAL recognizes this directive and forwards the signaling message to the mobile terminal 100 in a manner that enables it to be identified by the access gateway 32. For example, the message may be transmitted to the access gateway 32 over a specific port or may use a specified IP address. The access gateway 32 can then easily identify the packets requiring special handling by filtering the packets. Alternatively, the access gateway 32 could determine how to handle packets based on message content, but such message processing is not as efficient as packet filtering.

Adding a WAL controlled by a user application adds a great deal of flexibility without impacting the function of the SCP layer. Applications may function with or without the WAL, or with an adaptation layer that does not support all of the desired optimizations. WAL directives not supported will simply be ignored by the SCP layer and/or wireless adaptation layer functions that do not support the requested feature.

The present invention may, of course, be carried out in other specific ways than those herein set forth without departing from the essential features of the invention. The present embodiments are, therefore, to be considered in all respects as illustrative and not restrictive, and all changes coming within the meaning and equivalency range of the appended claims are intended to be embraced therein.

What is claimed is:

1. A signaling framework for wireless communications over an air interface of a wireless network comprising:
an application layer containing an application for communicating with a remote device and for generating adaptation control directives associated with signaling messages;
a wireless adaptation layer to control wireless communication resources of the wireless network used to transmit said signaling messages over said air interface responsive to said wireless adaptation control directives; and
a session control protocol layer between said application layer and said wireless adaptation layer to establish and maintain a communication session between the application and the remote device.

2. The signaling framework of claim 1 wherein said wireless adaptation control directives pass transparently through the session control protocol layer.

3. The signaling framework of claim 1 wherein said wireless adaptation layer is responsive to wireless adaptation control directives from applications in remote devices.

4. The signaling framework of claim 1 wherein said session control protocol layer includes a Session Initiation Protocol.

5. The signaling framework of claim 1 wherein said application inserts said wireless adaptation control directives into said signaling messages.

6. The signaling framework of claim 1 wherein said application uses different signaling ports to give the wireless adaptation control directives to said wireless adaptation layer.

7. The signaling framework of claim 6 wherein the wireless adaptation control directives comprise port information.

8. The signaling framework of claim 6 wherein the wireless adaptation layer processes each signaling message based on the port over which the signaling message is received.

9. A method of signaling over a wireless network, said method comprising:
generating signaling messages and associated wireless adaptation control directives at an application layer;
sending said signaling messages and the associated wireless adaptation control directives to a wireless adaptation layer disposed through a session control protocol layer;
receiving the signaling messages and the wireless adaptation control directives at said wireless adaptation control layer;
using the wireless adaptation control directives to control how the signaling messages are transmitted over the wireless network.

10. The method of claim 9 wherein said session control protocol transparently passes the wireless adaptation control directives to the wireless adaptation layer.

11. The method of claim 9 wherein said wireless adaptation layer is responsive to wireless adaptation control directives from applications in remote devices.

12. The method of claim 9 wherein said session control protocol layer includes a Session Initiation Protocol.

13. The method of claim 9 wherein said application layer inserts said wireless adaptation control directives into the signaling messages.

14. The method of claim 9 wherein sending the signaling messages and the wireless adaptation control directives to a wireless adaptation layer via a session control protocol layer includes sending the wireless adaptation control directives to said wireless adaptation layer through different ports.

15. The method of claim 14 wherein the session control protocol layer passes port information associated with wireless adaptation control directives to said wireless adaptation layer.

16. The method of claim 14 wherein the wireless adaptation layer processes each signaling message based on the port over which the signaling message is received.

17. A method of signaling over a wireless network, said method comprising:
generating signaling messages at an application layer, said signal messages having wireless adaptation control directives included therein;
sending said signaling messages to a wireless adaptation layer through a session control protocol layer;
receiving the signaling at said wireless adaptation control layer;
using the wireless adaptation control directives to control how the signaling messages should be transmitted over the wireless network.

18. The signaling framework of claim 17, wherein said wireless adaptation control directives transparently pass through the session control protocol layer.

19. The method of claim 17 wherein the session control protocol layer maintains a communication session between the application layer and a remote device.

20. The method of claim 17 wherein the wireless adaptation layer is responsive to wireless adaptation control directives from applications in remote devices.
